(19) United States
(12) Patent Application Publication
(10) Pub. No.: US 2008/0166529 A1
(43) Pub. Date: Jul. 10, 2008

(54) Transparent Moulding Compound

(75) Inventors: Harald Hager, Ludinghausen (DE); Franz-Erich Baumann, Dulmen (DE); Michael Beyer, Raesfeld (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/816,595

(22) PCT Filed: Jan. 4, 2006
(86) PCT No.: PCT/EP2006/050036

§ 371 Date: Mar. 25, 2008

(30) Foreign Application Priority Data
Feb. 19, 2005 (DE) 10 205 007 664.5

(51) Int. Cl. C08L 77/02; B32B 3/10

(52) U.S. Cl. 428/195.1; 525/432; 524/430; 524/607

(57) ABSTRACT

A molding composition which comprises the following components:
a) a semicrystalline copolyamide and
b) an effective amount of a crystallization aid selected from
   nanoscale fillers and
   metal salts, metal oxides, or metal hydroxides which can react with the carboxy end groups of the copolyamide,
      where the copolyamide can be prepared from the following monomer combination:
α) from 50 to 99 mol % of a lactam or of a corresponding co-aminocarboxylic acid having 8, 9, 10, 11, or 12 carbon atoms or of a substantially equimolar mixture composed of a diamine and of a dicarboxylic acid, where the diamine has been selected from the group of 1,6-hexamethylenediamine, 1,8-octamethylenediamine, 1,10-decamethylenediamine, and 1,12-dodecamethylenediamine, and the dicarboxylic acid has been selected from the group of sebacic acid and 1,12-dodecanedioic acid, and
β) from 1 to 50 mol % of a substantially equimolar mixture composed of a diamine and of a dicarboxylic acid, where either the diamine or the dicarboxylic acid or both differ from the diamine used, if appropriate, under α) and, respectively, the dicarboxylic acid used, if appropriate under α), or of another lactam and, respectively, ω-aminocarboxylic acid,
   is transparent and has good processability, and gives good results in decoration by means of screen printing.

The invention relates to a transparent molding composition composed of a copolyamide and suitable for production of transparent, printable items.

The utility model DE 295 19 867 U1 describes a decoratable film composed of a copolyamide which is composed of the monomer units laurolactam and caprolactam and/or hexamethylenediamine/dicarboxylic acid.

Although these copolyamides are generally transparent and also give good results in decorating via screen printing, because they have low crystallinity, when films are produced from these copolyamides via extrusion problems constantly arise. The films crystallize very slowly and only when low temperatures are reached, and this necessitates a long cooling section, or very low extrusion speeds. The slow crystallization also leads to distortion of the film and to shrinkage. When these films are printed by means of screen printing, they can easily become brittle as a result of stress cracking.

One part of the object consisted in developing transparent, semicrystalline copolyamide formulations for items such as moldings and films, these having rapid crystallization. Another part of the object consisted in producing, from transparent, semicrystalline copolyamide formulations, items which do not distort and do not shrink.

It would be obvious per se to achieve this object via addition of one of the conventional crystallization aids (nucleating agents). These aids have been known for a long time. However, they normally cause clouding, and sometimes cause fish-eyes, and, in low-thickness films, cause roughness on the film surface. This is unacceptable for the desired application.

DE 199 37 117 A1 discloses a film with a layer composed of a copolyamide with nanoscale nucleating particles dispersed therein; the copolyamide comprises units which derive from aromatic monomers; the remainder of the units is based on PA6 or PA6/66. The nucleation reduces the aftershrinkage of the film. The specification moreover says that the film can be printed; the methods used for this are not stated. This film is used as food packaging.

The article by M. Beyer and J. Lohmar, Kunststoffe 90 (2000) 1, pp. 98-101 gives examples of printable films composed of PA12 molding compositions. However, the transparency of these films and their screen-printability remain unsatisfactory.

One substantial aspect of the underlying object here is to provide a polyamide molding composition which can be processed to give items such as moldings or films, these having good screen-printability. This requires low crystallinity of the polyamide so that the colorant can be anchored via solvation of the polyamide in the surface of the item to be decorated.

Surprisingly, this object has been achieved via a molding composition which comprises the following components:
a) a semicrystalline copolyamide as given below and
b) an effective amount of a crystallization aid selected from
   nanoscale fillers and/or
   metal salts, metal oxides, or metal hydroxides which can react with the carboxy end groups of the copolyamide.

Surprisingly, these molding compositions gave good results in decoration by means of screen printing despite the forced crystallization.

Copolyamides which can be used according to the invention can be prepared from the following monomer combination:
α) from 50 to 99 mol %, preferably from 60 to 98 mol %, particularly preferably from 70 to 97 mol %, and with particular preference from 80 to 96 mol %, of a lactam or of the corresponding ω-aminocarboxylic acid having 8, 9, 10, 11, or 12 carbon atoms or of a substantially equimolar mixture composed of a diamine with a dicarboxylic acid, where diamine and dicarboxylic acid are in each case counted separately in calculations of the formulation, where the diamine has been selected from the group of 1,6-hexamethylenediamine, 1,8-octamethylenediamine, 1,10-decamethylenediamine, and 1,12-dodecamethylenediamine, and the dicarboxylic acid has been selected from the group of sebacic acid and 1,12-dodecanedioic acid, and
β) from 1 to 50 mol %, preferably from 2 to 40 mol %, particularly preferably from 3 to 30 mol %, and with particular preference from 4 to 20 mol %, of a substantially equimolar mixture composed of a diamine and of a dicarboxylic acid, where either the diamine or the dicarboxylic acid or both differ from the diamine used, if appropriate, under α) and, respectively, the dicarboxylic acid used, if appropriate under α), or of a lactam and, respectively, the corresponding ω-aminocarboxylic acid, which differ from the lactam used, if appropriate, and, respectively, the corresponding ω-aminocarboxylic acid of component α). Here again, diamine and dicarboxylic acid are in each case counted separately in calculations of the formulation. In one possible embodiment, either the diamine or the dicarboxylic acid, or both, is/are branched or cyclic.

Suitable diamines of component β) have from 4 to 40 carbon atoms; examples of compounds which may be used here are 1,6-hexamethylenediamine, 2-methyl-1,5-diaminopentane, 2,2,4- or 2,4,4-trimethylhexamethylenediamine, 1,9-nonamethylenediamine, 1,10-decamethylene-diamine, 4,4′-diaminodicyclohexylmethane, 3,3′-dimethyl-4,4′-diaminodicyclohexylmethane, 4,4′-diaminodicyclohexylpropane, 1,4-diaminocyclohexane, 1,4-bis(aminomethyl)cyclo-hexane, 2,6-bis(aminomethyl)norbornane, and 3-aminomethyl-3,5,5-trimethylcyclohexyl-amine. It is also possible to use a mixture of various diamines.

Suitable dicarboxylic acids of component β) likewise have from 4 to 40 carbon atoms; examples here are adipic acid, 2,2,4- or 2,4,4-trimethyladipic acid, azelaic acid, sebacic acid, 1,12-dodecanedioic acid, cyclohexane-1,4-dicarboxylic acid, 4,4′-dicarboxydicyclo-hexylmethane, 3,3′-dimethyl-4,4′-dicarboxydicyclohexylmethane, 4,4′-dicarboxydicyclo-hexylpropane, and 1,4-bis(carboxymethyl)cyclohexane. It is also possible to use a mixture of various dicarboxylic acids.

Suitable other lactams or corresponding ω-aminocarboxylic acids are those having 6, 7, 8, 9, 10, 11, or 12 carbon atoms.

The copolyamide used has a certain crystallinity in order to provide a minimum level of stress cracking resistance. The enthalpy of fusion of the molding composition, determined via DSC to DIN 53765 in the 2^{nd} heating curve using a heating rate of 20 K/min, is generally at least 10 J/g, preferably at least 15 J/g, and particularly preferably at least 20 J/g. The melting peak attributed to the crystallite melting point Tₘ here is generally at from 100 to 220° C., preferably from 120 to 210° C., and particularly preferably from 140 to 200° C.

The relative solution viscosity ηᵣₑₗ of the copolyamide, measured in a 0.5% strength by weight solution in m-cresol at 23° C. to ISO 307, is generally from about 1.5 to about 2.5, and preferably from about 1.7 to about 2.2. In one preferred embodiment, the melt viscosity, measured in a mechanical spectrometer (cone-and-plate) to ASTM D4440 at 240° C. and at a shear rate of 100 s⁻¹, is from 250 to 10 000 Pas, preferably from 350 to 8000 Pas, and particularly preferably from 500 to 5000 Pas.

An amount of from 0.001 to 5% by weight of the crystallization aid is generally added to the copolyamide.

Examples of nanoscale fillers are modified phyllosilicates. Their aspect ratio (quotient derived from lateral dimensions and layer thickness) is generally at least 20, preferably at least 30, and particularly preferably at least 50, the layer thickness being from 0.5 to 50 nm, preferably from 1 to 35 nm, and particularly preferably from 1 to 20 nm. Polymeric nanocomposites composed of organophilicized phyllosilicates and of polymers were first described in U.S. Pat. No. 2,531,396. The organophilicization of phyllosilicates is also disclosed by way of example in U.S. Pat. Nos. 2,531,472, 2,996,506, 4,105,578, 4,412,018, 4,434,075, 4,434,076, 4,450,095, and 4,874,728. An overview of the subject of phyllosilicates is found in Lehrbuch der Anorganischen Chemie [Textbook of inorganic chemistry], Arnold F. Holleman, Niels Wiberg, 91^{st}-100^{th} edition, Verlag Walter de Gruyter, Berlin-New York, 1985, pp. 764-786.

Organic modified phyllosilicates are now supplied by various companies, for example by Südchemie AG (trade mark: Nanofil), Southern Clay Products (trade mark: Cloisite), Rheox GmbH (trade mark: Bentone), Laporte (trade mark: Laponite), COOP Chemical (trade mark: Somasif), and TOP (trade mark: Planomer).

The preparation of polymeric nanocomposites from polyamides and from pretreated phyllosilicates is known. An overview of this subject is found in the following applications and articles: U.S. Pat. No. 5,721,306, EP-A-0 747451, WO 93/11190, WO 93/04118, WO 93/04117, EP-A-0 398 551, U.S. Pat. No. 4,739,007, U.S. Pat. No. 4,810,734, DE-A-38 10 006, U.S. Pat. No. 5,385,776; P. Reichert et al., Acta Polymer. 49, 116-223; A. Usuki et al., J. Mat. Res., 1993, 8, 1179; Y. Kojimma et al., J. Mat. Res., 1993, 8, 1185; Y. Kojimma et al., J. Appl. Sci., 1993, 49, 1259; L. Lin et al., J. Appl. Pol. Sci., 1999, 71, 1133-1138; B. Hoffmann et al., Colloid Pol. Sci., 2000, 278, 629-636.

EP-A-0 358 415 describes the preparation of polymeric nanocomposites via polymerization of lactams in the presence of pretreated phyllosilicates. This achieves an improvement in barrier properties with respect to gases, in heat resistance, and in stiffness.

The amounts introduced into the copolyamide matrix of the nanoscale fillers are preferably from 0.001 to 2% by weight, particularly preferably from 0.01 to 1.5% by weight, and with particular preference from 0.1 to 1% by weight, and this can be brought about via polycondensation in the presence of the filler, or else via subsequent incorporation by compounding. Particularly suitable nanoscale fillers are the phyllosilicates montmorillonite, hectorite, and saponite, and also synthetic phyllosilicates.

Suitable metal salts, metal oxides, and metal hydroxides react with the end groups of the copolyamide, whereupon the neutralized end groups produced have nucleating action. It is advantageous here for the copolyamide to have an excess of carboxy end groups. Compounds which may be used with particular advantage are alkali metal or alkaline earth metal carbonates or corresponding hydrogencarbonates. The reaction here produces water and carbon dioxide, which can be removed without difficulty from the copolyamide melt.

The amount preferably used of the metal salts, metal oxides, or metal hydroxides is preferably from 0.01 to 5% by weight, particularly preferably from 0.1 to 4% by weight, and with particular preference from 0.5 to 3% by weight, based on the copolyamide. Examples of suitable compounds are lithium carbonate, sodium carbonate, potassium carbonate, rubidium carbonate, magnesium carbonate, calcium carbonate, strontium carbonate, barium carbonate, sodium hydrogencarbonate, potassium hydrogencarbonate, sodium hydroxide, magnesium hydroxide, calcium hydroxide, magnesium oxide, calcium oxide, strontium oxide, and barium oxide. In order to ensure that the transparency is as desired, the amount added should generally be not more than that which can be dissolved in the melt, using reaction with the carboxy end groups.

It is also possible, of course, to use corresponding compounds of heavy metals, e.g. zinc carbonate. However, these compounds are often environmentally hazardous, and they frequently impair the aging resistance of the molding composition.

The molding composition may comprise auxiliaries and additives in the amounts conventional for polyamide molding compositions, examples being stabilizers or dyes.

The inventive molding composition can be used for production of items such as moldings or films, and these are likewise provided by the invention. In one preferred embodiment, the thickness of the films is from 0.05 to 1 mm, particularly preferably from 0.1 to 0.8 mm, and with particular preference from 0.2 to 0.6 mm.

The film may also be a multilayer film, and the following embodiments are preferred here:
1. The multilayer film comprises a further layer composed of a polyamide elastomer molding composition, in particular of a polyetheramide or of a polyetheresteramide, and preferably of a polyetheramide or polyetheresteramide based on a linear aliphatic diamine having from 6 to 18, and preferably from 6 to 12, carbon atoms, on a linear aliphatic or an aromatic dicarboxylic acid having from 6 to 18, and preferably from 6 to 12, carbon atoms, and on a polyether whose average number of carbon atoms per oxygen atom is more than 2.3 and whose number-average molecular weight is from 200 to 2000. The molding composition of this layer may comprise further blend components, e.g. polyacrylates or polyglutarimides having carboxy or carboxylic anhydride groups or epoxy groups, a rubber containing functional groups, and/or a polyamide. These molding compositions are prior art; they are described by way of example in EP 1 329 481 A2 and DE-A 103 33 005, expressly incorporated herein by way of reference. In order to provide good layer adhesion it is advantageous for the polyamide fraction of the polyamide elastomer to be composed of monomers which are the same as those used as monomer combination a) in the copolyamide of the other layer.
2. The multilayer film comprises a further layer composed of a molding composition based on the same, or on a similar, copolyamide, and/or on a polyamide which is preferably composed of monomers which are the same as those used as monomer combination a) in the copolyamide of the other layer.
3. The multilayer film comprises an adhesion-promoter layer for linkage to the substrate or for bonding within the multilayer film structure, for example comprises a polyolefin functionalized with carboxy or anhydride groups or functionalized with epoxy groups, or comprises a blend composed of the material of the bottom layer and of the substrate material, or comprises a thermoplastic polyurethane.

These embodiments may also be combined with one another. It is always preferable that the layer composed of the molding composition used according to the invention forms the outer layer. However, it may also be used as intermediate or lower layer. If necessary, for example if scratch resistance requirements are stringent, the outer layer may, if appropriate, also have been provided with a protective layer, for example with a clear lacquer based on polyurethane. It may also, if appropriate, have been covered with an assembly film which is peeled away after production of the finished part.

The second, lower layer, or, if there are more than 2 layers, one of the lower layers, may be a colorless transparent, transparent colored, or else opaquely colored layer, in order to permit production of specific design variants in combination with the transparent outer layer. In such instances, the transparent outer layer may additionally be printed from the upper side.

Examples of the use of the films are as protective film with respect to soiling, UV radiation, weathering effects, chemicals, or abrasion, as barrier film on vehicles, in the household, on floors, on tunnels, on tents, and on buildings, or as a carrier for decorative effects, for example for overcoatings on sports equipment, or internal or external decoration on motor vehicles, on boats, in the household, or on buildings. These possible uses also apply to cases in which the molding composition is an opaquely colored composition. Examples of methods for producing the cohesive bond between film and substrate are adhesive bonding, pressing, lamination, coextrusion, or in-mold coating. To achieve improved adhesion, the film may be pre-flame-treated or pre-plasma-treated, for example.

The invention is illustrated below by examples.

### COMPARATIVE EXAMPLE 1

A copolyamide composed of 80 mol % of laurolactam and 20 mol % of caprolactam is used; ηᵣₑₗ=1.9; amino group concentration 30 mmol/kg; carboxy group concentration 60 mmol/kg.

### COMPARATIVE EXAMPLE 2

A copolyamide composed of 80 mol % of laurolactam and 20 mol % of an equimolar mixture composed of hexamethylenediamine and dodecanedioic acid is used. ηᵣₑₗ=1.89; amino group concentration 37 mmol/kg; carboxy group concentration 60 mmol/kg.

### COMPARATIVE EXAMPLE 3

A copolyamide composed of 85 mol % of laurolactam, 7.5 mol % of isophoronediamine, and 7.5 mol % of 1,12-dodecanedioic acid is used. ηᵣₑₗ=1.85; amino group concentration 45 mmol/kg; carboxy group concentration 42 mmol/kg.

### INVENTIVE EXAMPLE 1

A copolyamide identical with that in Comparative example 1 was mixed in the melt with 0.1% by weight of NANOFIL® 804, an organically modified phyllosilicate of bentonite type from Südchemie AG, D-85368 Moosburg in a twin-screw extruder, and extruded and pelletized. ηᵣₑₗ=1.9.

### INVENTIVE EXAMPLE 2

In production of a copolyamide identical with that in Comparative example 2, 0.1% by weight of NANOFIL® 804, based on the copolyamide to be prepared, was mixed with the laurolactam, and the entire mixture was then polymerized after addition of the other monomers. The product was extruded and pelletized. ηᵣₑₗ=1.76; amino group concentration 35 mmol/kg; carboxy group concentration 67 mmol/kg.

### INVENTIVE EXAMPLE 3

In production of a copolyamide identical with that in Comparative example 3, 0.1% by weight of NANOFIL® 804, based on the copolyamide to be prepared, was mixed with the laurolactam, and the entire mixture was then polymerized after addition of the other monomers. The product was extruded and pelletized. ηᵣₑₗ=1.73; amino group concentration 22 mmol/kg; carboxy group concentration 37 mmol/kg.

### INVENTIVE EXAMPLE 4

In production of a copolyamide identical with that in Comparative example 1, from the start of the polymerization an amount of sodium carbonate equivalent to the carboxy group content of 60 mmol/kg to be achieved was added. The product was extruded and pelletized. ηᵣₑₗ=1.9.

### INVENTIVE EXAMPLE 5

In production of a copolyamide identical with that in Comparative example 2, from the start of the polymerization an amount of sodium carbonate equivalent to the carboxy group content of 75 mmol/kg to be achieved was added. The product was extruded and pelletized. ηᵣₑₗ=1.76.

### INVENTIVE EXAMPLE 6

In production of a copolyamide identical with that in Comparative example 3, 0.1% by weight of the phyllosilicate BENTONE® 38 (an organically modified hectorite from Rheox GmbH, D-51307 Leverkusen), based on the copolyamide to be prepared, was mixed with the laurolactam, and the entire mixture was polymerized after addition of the other monomers. The product was extruded and pelletized. ηᵣₑₗ=1.76; amino group concentration 25 mmol/kg; carboxy group concentration 31 mmol/kg.

### COMPARATIVE EXAMPLE 4

A copolyamide identical with that in Comparative example 1 was mixed in the melt with 0.1% by weight of the nucleating agent microtalc IT extra-fine in a twin-screw extruder, extruded, and pelletized. ηᵣₑₗ=1.9.

Films of thickness 0.4 mm were extruded from the products of Inventive examples 1 to 6, and also of Comparative examples 1 to 4, and were assessed. The results are shown in the table below.

For the molding compositions with poor processability, marked distortion was noticeable, due to slow post-crystallization.

TABLE
Assessment of molding compositions

| | | | Crystallite | Crystal- | |
|---|---|---|---|---|---|
| Molding | | | melting | lization | Enthalpy |
| composition | Trans- | Process- | point | temperature | of fusion |
| composed of | parency | ability | Tₘ [° C.] | [° C.] | [J/g] |
| Comparative | good | poor | 150 | 85 | 40 |
| example 1 | | | | | |
| Comparative | good | poor | 159 | 89 | 39 |
| example 2 | | | | | |
| Comparative | good | poor | 158 | 90 | 41 |
| example 3 | | | | | |
| Comparative | fish-eyes | good | 150 | 110 | 50 |
| example 4 | present | | | | |
| Inventive | good | good | 150 | 110 | 55 |
| example 1 | | | | | |
| Inventive | good | good | 160 | 114 | 48 |
| example 2 | | | | | |
| Inventive | good | good | 163 | 112 | 47 |
| example 3 | | | | | |
| Inventive | good | good | 150 | 109 | 45 |
| example 4 | | | | | |
| Inventive | good | good | 160 | 113 | 47 |
| example 5 | | | | | |
| Inventive | good | good | 163 | 111 | 44 |
| example 6 | | | | | |

All of the films gave good results in decoration by means of screen printing.

1-18. (canceled)

19. A molding composition which comprises the following components:
a) a semicrystalline copolyamide and
b) from 0.001 to 5% by weight of a crystallization aid selected from metal salts, metal oxides, or metal hydroxides which can react with the carboxy end groups of the copolyamide,
characterized in that the copolyamide can be prepared from the following monomer combination:
α) from 50 to 99 mol % of a lactam or of a corresponding ω-aminocarboxylic acid having 8, 9, 10, 11, or 12 carbon atoms or of a substantially equimolar mixture composed of a diamine and of a dicarboxylic acid, where the diamine has been selected from the group of 1,6-hexamethylenediamine, 1,8-octamethylenediamine, 1,10-decamethylenediamine, and 1,12-dodecamethylenediamine, and the dicarboxylic acid has been selected from the group of sebacic acid and 1,12-dodecanedioic acid, and
β) from 1 to 50 mol % of a substantially equimolar mixture composed of a diamine and of a dicarboxylic acid, where either the diamine or the dicarboxylic acid or both differ from the diamine used, if appropriate, under α) and, respectively, the dicarboxylic acid used, if appropriate under α), or of a lactam and, respectively, the corresponding ω-aminocarboxylic acid, which differ from the lactam used, if appropriate, and, respectively, the corresponding co-aminocarboxylic acid of component α).

20. The molding composition as claimed in claim 19, characterized in that
its enthalpy of fusion is at least 10 J/g.

21. The molding composition as claimed in claim 19, characterized in that
its enthalpy of fusion is at least 15 J/g.

22. The molding composition as claimed in claim 19, characterized in that
its enthalpy of fusion is at least 20 J/g.

23. The molding composition as claimed in claim 19, characterized in that
its crystallite melting point Tₘ is from 100 to 220° C.

24. The molding composition as claimed in claim 19, characterized in that
its crystallite melting point Tₘ is from 120 to 210° C.

25. The molding composition as claimed in claim 19, characterized in that
its crystallite melting point Tₘ is from 140 to 200° C.

26. The molding composition as claimed in claim 19, characterized in that
the amount of the crystallization aid added to the copolyamide is from 0.001 to 5% by weight.

27. The method of using a molding composition which comprises the following components:
a) a semicrystalline copolyamide and
b) an effective amount of a crystallization aid
selected from
nanoscale fillers and/or
metal salts, metal oxides, or metal hydroxides which can react with the carboxy end groups of the copolyamide,
characterized in that the copolyamide can be prepared from the following monomer combination:
α) from 50 to 99 mol % of a lactam or of a corresponding ω-aminocarboxylic acid having 8, 9, 10, 11, or 12 carbon atoms or of a substantially equimolar mixture composed of a diamine and of a dicarboxylic acid, where the diamine has been selected from the group of 1,6-hexamethylenediamine, 1,8-octamethylenediamine, 1,10-decamethylenediamine, and 1,12-dodecamethylenediamine, and the dicarboxylic acid has been selected from the group of sebacic acid and 1,12-dodecanedioic acid, and
β) from 1 to 50 mol % of a substantially equimolar mixture composed of a diamine and of a dicarboxylic acid, where either the diamine or the dicarboxylic acid or both differ from the diamine used, if appropriate, under α) and, respectively, the dicarboxylic acid used, if appropriate under α), or of a lactam and, respectively, the corresponding ω-aminocarboxylic acid, which differ from the lactam used, if appropriate, and, respectively, the corresponding ω-aminocarboxylic acid of component α),
for producing an item subjected to printing on a surface composed of this molding composition.

28. The method of using as claimed in claim 27, characterized in that
the printed item is a molding or a foil.

29. A printed item produced from the molding composition used as claimed in claim 9.

30. The printed item as claimed in claim 29, characterized in that
it is a molding or a foil.

31. A foil as claimed in claim 30, characterized in that
its thickness is from 0.05 to 1 mm.

32. The foil as claimed in claim 30, characterized in that
its thickness is from 0.1 to 0.8 mm.

33. The foil as claimed in claim 30, characterized in that
its thickness is from 0.2 to 0.6 mm.

34. The foil as claimed in claim 30, characterized in that
it is a multilayer foil.
